(19) United States
(12) Patent Application Publication
(10) Pub. No.: US 2011/0056612 A1
(43) Pub. Date: Mar. 10, 2011

(54) Method for Producing Polymer Sheet for Inner Liner and Method for Producing Pneumatic Tire

(76) Inventor: Mutsuki SUGIMOTO, Kobe-shi (JP)

(21) Appl. No.: 12/859,080

(22) Filed: Aug. 18, 2010

(30) Foreign Application Priority Data
Sep. 10, 2009 (JP) 2009-209633

(51) Int. Cl. B05D 7/22; B29D 30/40

(52) U.S. Cl. 156/110.1; 427/413

(57) ABSTRACT

The present invention provides a polymer sheet for an inner liner and a method for producing a pneumatic tire, which do not cause an air-in phenomenon between an inner liner and an insulation rubber or a carcass rubber in the vulcanization step, and also can prevent adhesion between the inner liner and a bladder. The method for producing a polymer sheet for an inner liner includes the steps of preparing an unvulcanized polymer sheet made of a polymer mixture containing 99 to 60% by mass of a styrene-isobutylene-styrene triblock copolymer, and 1 to 40% by mass of a polyamide-based polymer containing polyamide in the molecular chain and having a Shore D hardness of 70 or less, and at least one of the steps of coating one surface of the unvulcanized polymer sheet with a water-soluble paint 2 to 5 times, and coating with a mold-releasing rubber in a thickness of 0.001 mm to 0.1 mm.f.

This nonprovisional application is based on Japanese Patent Application No. 2009-209633 filed on Sep. 10, 2009 with the Japan Patent Office, the entire contents of which are hereby incorporated by reference.

### BACKGROUND OF THE INVENTION

1. Field of the Invention

The present invention relates to a method for producing a polymer sheet for an inner liner, and a method for producing a pneumatic tire.

2. Description of the Background Art

Recently, an attempt has been made to perform weight saving of tires because of strong social demands for fuel economy of automobiles. An attempt has also been made to perform weight saving of inner liners, among tire members, that are disposed inside tires and have the function of improving air permeation resistance by decreasing the amount of air leaked to the outside from the inside of pneumatic tires (air permeation amount).

In a rubber composition for an inner liner, an improvement in air permeation resistance of tires is performed by using a butyl-based rubber containing 70 to 100% by mass of a butyl rubber and 30 to 0% by mass of a natural rubber. The butyl-based rubber contains, in addition to butylenes, about 1% by mass of isoprene, that enables cocrosslinking with an adjacent rubber, along with sulfur, a vulcanization accelerator and zinc white. In the case of a conventional formulation, the butyl-based rubber requires the thickness of about 0.6 to 1.0 mm for tires for passenger cars, or the thickness of about 1.0 to 2.0 mm for trucks and buses.

In order to perform weight saving of tires, it is proposed to use a thermoplastic elastomer as an inner liner since it is excellent in air permeation resistance as compared with the butyl-based rubber and can further decrease the thickness of the inner liner layer. However, the thermoplastic elastomer that shows high air permeation resistance in the smaller thickness than that of the butyl-based rubber is inferior in vulcanization adhesive strength with an insulation rubber or a carcass rubber adjacent to the inner liner as compared with the butyl-based rubber. When the inner liner has low vulcanization adhesive strength, air permeates into the space between the inner liner and the insulation rubber or the carcass rubber, and thus a number of small air bubbles appear (this phenomenon is called an air-in phenomenon). Although this phenomenon does not cause deterioration of tire performance, there is a problem that a small spot pattern formed inside tires gives an impression of poor appearance to users.

Japanese Patent Laying-Open No. 09-165469 proposes a pneumatic tire capable of improving adhesion between an inner liner and a rubber composition that forms the inner surface of the tire or the carcass layer by forming an inner liner layer using nylon having low air permeability. However, in the technique of Japanese Patent Laying-Open No. 09-165469, there is a problem that a rubber cement composed of a rubber composition must be bonded after subjecting a nylon film to an RFL treatment so as to form a nylon film layer, resulting in complicated steps. Furthermore, in the vulcanization step, there is usually employed a tire vulcanization method in which a bladder body is inserted into an unvulcanized tire (green tire) accommodated in a mold and the bladder body is expanded, and then vulcanization molding is performed by pressing the tire against the inner surface of the mold from the inside of the unvulcanized tire. There is also a problem that, in the inner liner layer of Japanese Patent Laying-Open No. 09-165469, the nylon film layer is brought into contact with the bladder in a heated state, and thus the nylon film layer is adhered and bonded to the bladder.

### SUMMARY OF THE INVENTION

An object of the present invention is to provide a polymer sheet for an inner liner and a method for producing a pneumatic tire, which do not cause an air-in phenomenon between an inner liner and an insulation rubber or a carcass rubber in the vulcanization step, and also can prevent adhesion between the inner liner and a bladder.

The method for producing a polymer sheet for an inner liner according to the present invention includes the steps of preparing an unvulcanized polymer sheet made of a polymer mixture containing 99 to 60% by mass of a styrene-isobutylene-styrene triblock copolymer, and 1 to 40% by mass of a polyamide-based polymer containing polyamide in the molecular chain and having a Shore D hardness of 70 or less, and at least one of the steps of coating one surface of the unvulcanized polymer sheet with a water-soluble paint 2 to 5 times, and coating with a mold-releasing rubber in a thickness of 0.001 mm to 0.1 mm.

In the method for producing a polymer sheet for an inner liner according to the present invention, the polymer mixture preferably contains 15 to 30% by mass of an ethylene-vinyl alcohol copolymer.

In the method for producing a polymer sheet for an inner liner according to the present invention, the styrene-isobutylene-styrene triblock copolymer preferably contains 10 to 30% by mass of a styrene unit.

In the method for producing a polymer sheet for an inner liner according to the present invention, the polyamide-based polymer is preferably a block copolymer of a polyamide component and a polyether component.

The method for producing a pneumatic tire according to the present invention includes the steps of preparing a green tire with an inner liner made of a polymer mixture containing 99 to 60% by mass of a styrene-isobutylene-styrene triblock copolymer, and 1 to 40% by mass of a polyamide-based polymer containing polyamide in the molecular chain and having a Shore D hardness of 70 or less, and at least one of the steps of coating a radial inner surface of the green tire of the green inner liner with a water-soluble paint 2 to 5 times, and coating with a mold-releasing rubber in a thickness of 0.001 mm to 0.1 mm.

In the method for producing a pneumatic tire according to the present invention, the polymer mixture preferably contains 15 to 30% by mass of an ethylene-vinyl alcohol copolymer.

In the method for producing a pneumatic tire according to the present invention, the styrene-isobutylene-styrene triblock copolymer preferably contains 10 to 30% by mass of a styrene unit.

In the method for producing a pneumatic tire according to the present invention, the polyamide-based polymer is preferably a block copolymer of a polyamide component and a polyether component.

According to the present invention, it is possible to provide a method for producing a polymer sheet for an inner liner and a method for producing a pneumatic tire, which do not cause an air-in phenomenon between an inner liner and an insulation rubber or a carcass rubber in the vulcanization step, and also can prevent adhesion between the inner liner and a bladder.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view showing the right half of a pneumatic tire in one embodiment of the present invention.

### DESCRIPTION OF THE PREFERRED EMBODIMENTS

### Method for Producing Polymer Sheet for Inner Liner

In one embodiment of the present invention, the method for producing a polymer sheet for an inner liner includes the following steps. An unvulcanized polymer sheet made of a polymer mixture containing 99 to 60% by mass of a styrene-isobutylene-styrene triblock copolymer, and 1 to 40% by mass of a polyamide-based polymer containing polyamide in the molecular chain and having a Shore D hardness of 70 or less is prepared. One surface of the polymer sheet is coated with a mold-releasing agent.

### <Step of Preparing Unvulcanized Polymer Sheet>

The unvulcanized polymer sheet used in one embodiment of the present invention is made of a polymer mixture containing 99 to 60% by mass of a styrene-isobutylene-styrene triblock copolymer and 1 to 40% by mass of a polyamide-based polymer containing polyamide in the molecular chain and having a Shore D hardness of 70 or less.

### (Polymer Mixture)

The polymer mixture contains 99 to 60% by mass of a styrene-isobutylene-styrene triblock copolymer (hereinafter may also be referred to as an SIBS) and 1 to 40% by mass of a polyamide-based polymer containing polyamide in the molecular chain and having a Shore D hardness of 70 or less.

Because of the isobutylene moiety of the SIBS, when an unvulcanized polymer sheet made of the polymer mixture is used for an inner liner after vulcanization, the resultant inner liner has excellent air permeation resistance and durability. The SIBS has excellent durability since a molecular structure other than those of aromatic molecules is completely saturated and therefore deterioration and hardening are suppressed. Because of contribution of the polyamide moiety of the polyamide-based polymer, when an unvulcanized polymer sheet made of the polymer mixture is used for an inner liner after vulcanization, it becomes possible to bond the sheet with an unsaturated polymer and thus adhesion with an adjacent rubber such as an insulation rubber or a carcass rubber is improved.

Furthermore, in one embodiment of the present invention, when a pneumatic tire is produced by applying the unvulcanized polymer sheet made of the polymer mixture for an inner liner, a halogenated rubber having high specific gravity, which has hitherto been used so as to impart air permeation resistance, such as a halogenated butyl rubber, is not used in order to ensure air permeation resistance by the addition of the SIBS. Also when the halogenated rubber is used, it is possible to decrease the amount of use. Therefore, weight saving of the tire can be performed and the effect of improving fuel efficiency can be obtained. Furthermore, the halogenated rubber has a problem that adhesion between a ply cord and a rubber of a pneumatic tire is deteriorated due to halogens in the rubber. However, since the amount of use of the halogenated rubber can be decreased in the present invention, the effect of improving durability of the pneumatic tire due to an improvement in the adhesion between the ply cord and the polymer mixture is also obtained.

### (Styrene-Isobutylene-Styrene Triblock Copolymer)

In the polymer mixture, the content of the SIBS is adjusted within a range from 99 to 60% by mass. When the content of the SIBS is 60% by mass or more, an inner liner having excellent air permeation resistance and durability can be obtained. The content is preferably adjusted within a range from 95 to 80% by mass since the air permeation resistance and durability become more satisfactorily.

The SIBS usually contains 10 to 40% by mass of a styrene unit. The content of the styrene unit is preferably adjusted within a range from 10 to 30% by mass since the air permeation resistance and durability become more satisfactorily.

In the SIBS, a molar ratio (isobutylene unit/styrene unit) of an isobutylene unit to a styrene unit is preferably from 40/60 to 95/5 in view of the rubber elasticity of the copolymer. In the SIBS, the polymerization degree of each block is preferably from about 10,000 to 150,000 for an isobutylene block, or preferably from about 5,000 to 30,000 for a styrene block, in view of the rubber elasticity and handling (when the polymerization degree is less than 10,000, a liquid is obtained).

The SIBS can be obtained by a conventional polymerization method of a vinyl-based compound and, for example, it can be obtained by a living cationic polymerization method.

For example, Japanese Patent Laying-Open No. 62-048704 and Japanese Patent Laying-Open No. 64-062308 disclose that living cationic polymerization of isobutylene with other vinyl compounds can be performed and a polyisobutylene-based block copolymer can be produced by using isobutylene and other compounds as the vinyl compound. In addition, the method for production of a vinyl compound polymer by a living cationic polymerization method is described, for example, in U.S. Pat. No. 4,946,899, U.S. Pat. No. 5,219,948 and Japanese Patent Laying-Open No. 03-174403.

The SIBS does not have a double bond other than an aromatic double bond in the molecule and has high stability to ultraviolet rays as compared with a polymer having a double bond in the molecule, for example, polybutadiene, and therefore has satisfactory weatherability. Furthermore, although it does not have a double bond in the molecule and is a saturated rubbery polymer, a refractive index (nD) at 20° C. of light having a wavelength of 589 nm is 1.506, as described in Polymer Handbook, Willy, 1989. This is significantly higher than that of other saturated rubbery polymers, for example, an ethylene-butene copolymer.

### (Polyamide-Based Polymer)

In the polymer mixture, the content of the polyamide-based polymer is adjusted within a range from 1 to 40% by mass. When the content of the polyamide-based polymer is 40% by mass or less, the inner liner obtained by vulcanizing an unvulcanized polymer sheet made of the polymer mixture has both durability and adhesion. Since it is possible to ensure durability and adhesion and to add a larger amount of the SIBS and an ethylene-vinyl alcohol copolymer which are excellent in air permeation resistance, the content is preferably adjusted within a range from 3 to 20% by mass.

The polyamide-based polymer is preferably a polyamide-based polymer having a Shore D hardness of 70 or less. A Shore D hardness exceeding 70 is not preferred since cracking properties upon tire flexing and transfer are deteriorated. The Shore D hardness is preferably within a range from 15 to 70, more preferably from 18 to 70, still more preferably from 20 to 70, and particularly preferably from 25 to 70.

The polyamide-based polymer preferably contains 50% by mass or more of the following polyether amide elastomer (X):

a polyether amide elastomer (X) that is a block copolymer composed of a polyamide component and a polyether component, obtained by polymerizing a triblock polyether diamine compound (A) represented by the following formula (I), a polyamide-forming monomer (B) and a dicarboxylic acid compound (C):

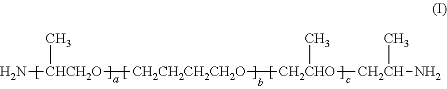

wherein a and b represent 1 to 20, and c represents 4 to 50.

The polyamide-forming monomer (B) is preferably at least one of compounds represented by the following formulas (II) and (III):

H₂N—R¹—COOH (II)

wherein R¹ represents a linking group containing a hydrocarbon chain; and

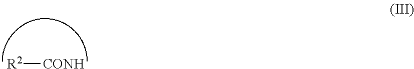

wherein R² represents a linking group containing a hydrocarbon chain.

The dicarboxylic acid compound (C) is preferably at least one kind of a compound selected from the group consisting of a compound represented by the following formula (IV), an aliphatic dicarboxylic acid compound and an alicyclic dicarboxylic acid compound:

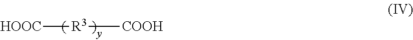

wherein R³ represents a linking group containing a hydrocarbon chain, and y represents 0 or 1.

When the polyamide-based polymer is a polyamide-based polymer having a hard segment derived from a polyamide component and a soft segment derived from a polyether component, it shows low crystallinity. Therefore, it is possible to obtain a polyamide-based polymer that has a high elongation at break EB and shows flexibility within a temperature range from a low temperature to a high temperature.

The polyamide-based polymer can exhibit an excellent effect in the adhesion with an adjacent rubber since fluidity improves at the tire vulcanization temperature (140 to 180° C.) and also wettability with the uneven surface improves.

As the polyamide-based polymer, a known polyamide-based polymer can be used. As the polyamide-based polymer, for example, an elastomer constituted from a polyamide block composed of at least one kind of aliphatic nylon selected from the group consisting of nylon 6, nylon 66, nylon 11 and nylon 12, and at least one kind of a polyether block selected from the group consisting of polyoxyethylene, polyoxypropylene and polyoxybutylene can be used.

The method for producing the polyamide-based polymer is not particularly limited and methods disclosed in Japanese Patent Laying-Open No. 56-065026, Japanese Patent Laying-Open No. 55-133424 and Japanese Patent Laying-Open No. 63-095251 can be employed.

The polymer mixture may contain, in addition to the SIBS and a polyamide-based polymer containing polyamide in the molecular chain and having a Shore D hardness of 70 or less, other polymers or resins. For example, the polymer mixture can contain an ethylene-vinyl alcohol copolymer, nylon, PET, a chlorobutyl rubber, a natural rubber, an ethylene-propylene-diene tercopolymer (EPDM), a styrene-butadiene rubber (SBR), a butadiene rubber, an isoprene rubber, a butyl rubber, a halogenated butyl rubber and an acrylonitrile-butadiene rubber (NBR).

### (Ethylene-Vinyl Alcohol Copolymer)

The polymer mixture preferably contains 15 to 30% by mass of an ethylene-vinyl alcohol copolymer. When the content of the ethylene-vinyl alcohol copolymer in the polymer mixture is 15% by mass or more, it is possible to ensure gas barrier properties of the inner liner obtained by vulcanizing an unvulcanized polymer sheet made of the polymer mixture. When the content is 30% by mass or less, it is possible to ensure the kneadability in the production of an unvulcanized polymer sheet and to ensure basic performance such as mechanical strength in the inner liner layer of the tire. Furthermore, durability of the tire becomes satisfactory. The content is more preferably adjusted to 20% by mass or more, and still more preferably 25% by mass or more.

The ethylene-vinyl alcohol copolymer is preferably represented by the following general formula (V):

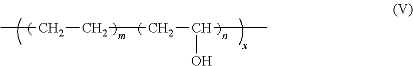

wherein m and n each independently represent 1 to 100, and x represents 1 to 1,000.

Compatibility with other compounding agents in the polymer mixture is satisfactorily imparted by the ethylene-derived moiety of the ethylene-vinyl alcohol copolymer, and the ethylene-vinyl alcohol copolymer can exist in a fine dispersion size in the unvulcanized polymer sheet. The ethylene-vinyl alcohol copolymer has satisfactory gas barrier properties due to contribution of the vinyl alcohol-derived moiety. That is, in the present invention, when the ethylene-vinyl alcohol copolymer having excellent gas barrier properties is dispersed in the form of islands in a fine size in the unvulcanized polymer sheet, satisfactory gas barrier properties are exhibited even when a thin inner liner layer is formed. Thus, it is possible to perform weight saving of the tire, and the effect of improving fuel efficiency is obtained.

In the general formula (V), m and n are adjusted to 1 or more so as to constitute an ethylene-vinyl alcohol copolymer. When m and n each are 100 or less, it is possible to obtain an ethylene-vinyl alcohol copolymer that has both compatibility with other compounding agents in the polymer mixture and gas barrier properties. Since compatibility with other compounding agents in the polymer mixture is further improved, m is more preferably adjusted to 5 or more. Since gas barrier properties are further improved, n is more preferably adjusted to 5 or more. Since it is hard to fail to exhibit gas barrier properties due to the vinyl alcohol-derived moiety, m is more preferably adjusted to 95 or less, and still more preferably 80 or less. Since it is hard to fail to exhibit satisfactory compatibility with other compounding agents in the polymer mixture due to the ethylene-derived moiety, n is more preferably adjusted to 95 or less, and still more preferably 80 or less.

In the general formula (V), x is adjusted to 1 or more so as to constitute the ethylene-vinyl alcohol copolymer. When x is 1,000 or less, kneadability in the production of the unvulcanized polymer sheet is ensured and an unvulcanized polymer sheet containing an ethylene-vinyl alcohol copolymer dispersed uniformly therein is obtained. Since satisfactory compatibility with other compounding agents in the polymer mixture and gas barrier properties are exhibited, x is more preferably adjusted to 10 or more. In view of satisfactory kneadability, x is more preferably adjusted to 500 or less, and still more preferably 100 or less.

The ethylene-vinyl alcohol copolymer represented by the general formula (V) may be contained in the polymer composition in a state of being copolymerized with other components. In this case, the content of the ethylene-vinyl alcohol copolymer means the content of the structure moiety represented by the general formula (V).

The molecular structure of the ethylene-vinyl alcohol copolymer can be confirmed, for example, by an infrared absorption spectrum (IR) and a nuclear magnetic resonance spectrum (NMR).

### (Unvulcanized Polymer Sheet)

In one embodiment of the present invention, it is preferred that the unvulcanized polymer sheet further contains a compatibilizing agent represented by the following general formula (VI):

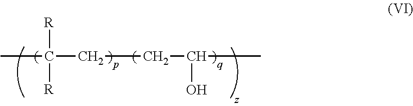

wherein R is an alkyl group, p and q each independently represent 1 to 100, and z is 1 to 5. The compatibilizing agent has the effect of further improving the compatibility between the ethylene-vinyl alcohol copolymer and other compounding agents in the polymer mixture in the unvulcanized polymer sheet. When p and q in the general formula (VI) each represent 1 or more, a satisfactory effect of the compatibilizing agent is exerted. When p and q each represent 100 or less, dispersibility of the compatibilizing agent in the unvulcanized polymer sheet is satisfactory. p is more preferably 5 or more and also more preferably 95 or less, and still more preferably 80 or less. q is more preferably 5 or more and also more preferably 95 or less, and still more preferably 80 or less.

z in the general formula (VI) is adjusted to 1 or more so as to constitute a block copolymer. In view of satisfactory dispersibility of the compatibilizing agent in the unvulcanized polymer sheet, z is preferably adjusted to 5 or less. Z is more preferably 2 or more, and still more preferably 4 or less.

The content of the compatibilizing agent represented by the general formula (VI) in the unvulcanized polymer sheet is preferably adjusted within a range from 0.1 to 4.8% by mass. When the content is 0.1% by mass or more, the satisfactory effect as the compatibilizing agent is exhibited. When the content is 4.8% by mass or less, it is possible to satisfactorily prevent deterioration of basic performance such as mechanical strength in the inner liner layer of the tire. The content is more preferably adjusted to 0.5% by mass or more, still more preferably 1.0% by mass or more, and even more preferably 1.5% by mass or more, and more preferably adjusted to 4.3% by mass or less, still more preferably 3.8% by mass or less, and even more preferably 3.4% by mass or less.

The compatibilizing agent represented by the general formula (VI) may be contained in the unvulcanized polymer sheet in a state of being copolymerized with other components. In this case, the content of the compatibilizing agent means the content of the structure moiety represented by the general formula (VI).

The unvulcanized polymer sheet can contain various compounding agents and additives, that are added to a polymer composition for tires or a conventional polymer composition, such as other reinforcing agents, vulcanization agents, vulcanization accelerators, various oils, antioxidants, softeners, plasticizers and coupling agents. The contents of these compounding agents and additives can be adjusted to appropriate amounts.

The unvulcanized polymer sheet can be produced by a conventionally known method and examples of the method include a method in which the above materials are weighed according to a predetermined formulation and then kneaded at 100 to 250° C. for 5 to 60 minutes using a rubber kneader such as an open roll or a Banbury mixer.

<Step of Coating one Surface of Unvulcanized Polymer Sheet with Mold-Releasing Agent>

Next, one surface of the unvulcanized polymer sheet thus prepared is coated with a mold-releasing agent. By coating one surface of the unvulcanized polymer sheet before the vulcanization step with the mold-releasing agent, it is possible to prevent adhesion between a polymer sheet for an inner liner and a bladder in the vulcanization step using the bladder, to improve mold releasability, to prevent an air-in phenomenon and to improve appearance of the tire.

As the mold-releasing agent, at least one of a water-soluble paint and a mold-releasing rubber can be used.

As the water-soluble paint, for example, there can be used a silicone-based paint composed mainly of an emulsion of silicone oil, mica having an increased content of an inorganic filler, a talc-based paint, and a nonsilicone-based paint prepared by adding a powder (mica or talc) to polyglycol with low viscosity.

These water-soluble paints can be obtained by a known production method.

These water-soluble paints can prevent adhesion between a polymer sheet for an inner liner and a bladder rubber by the effect of silicone or the inorganic filler, and thus mold releasability can be improved.

When the water-soluble paint is used as the mold-releasing agent, it is preferred to coat one surface side to be made in contact with the bladder of the unvulcanized polymer sheet with a water-soluble paint 2 to 5 times. When the number of coating times of the water-soluble paint is less than 2, mold releasability between the polymer sheet for an inner liner and the bladder after vulcanization deteriorates and an air-in phenomenon may occur. When the number of coating times of the water-soluble paint is more than 5, the number of production steps increases and it is not preferred in view of productive efficiency. The number of coating times of the water-soluble paint is more preferably from 3 to 4.

As the coating method of the water-soluble paint, dipping can be used.

As the coating method of the spray-type mold-releasing rubber, a spray gun can be used. As the coating method of the coating-type mold-releasing rubber, roller coating, brush coating, a roll coater and a flow coater can be used.

Examples of the mold-releasing rubber includes a spray-type mold-releasing rubber and a coating-type mold-releasing rubber.

The spray-type mold-releasing rubber can be produced, for example, by the following methods.

A rubber composition is prepared by mixing 100 parts by mass of a rubber component containing at least one kind of a natural rubber (NR), an isoprene rubber (IR), a butadiene rubber (BR), a styrene-butadiene rubber (SBR), a butyl rubber (IIR), an NBR (nitrile rubber), an ENR (epoxidized natural rubber), an EPDM (ethylene-propylene-diene tercopolymer), a silicone rubber and a urethane rubber with 0.1 to 5 parts by mass of sulfur, 0.5 to 5 parts by mass of a vulcanization accelerator, 0.5 to 5 parts by mass of an auxiliary vulcanization accelerator and 1 to 10 parts by mass of an antioxidant. A spray-type mold-releasing rubber can be obtained by mixing the rubber composition with at least one kind of naphtha, xylene, butane, hexane, isohexane isomers, ethylbenzene, methyl n-amyl ketone, isobutyl acetate and ethyl 3-ethoxy group propionic acid salt in a mixing ratio of 1:99 (the amount of the rubber composition is regarded as 1).

The coating-type mold-releasing rubber can be produced, for example, by the following method.

A rubber composition is prepared by mixing 100 parts by mass of a rubber component containing at least one kind of a natural rubber (NR), an isoprene rubber (IR), a butadiene rubber (BR), a styrene-butadiene rubber (SBR), a butyl rubber (IIR), an NBR (nitrile rubber), an ENR (epoxidized natural rubber), an EPDM (ethylene-propylene-diene tercopolymer), a silicone rubber and a urethane rubber with 0.1 to 5 parts by mass of sulfur, 0.5 to 5 parts by mass of a vulcanization accelerator and 0.5 to 5 parts by mass of an auxiliary vulcanization accelerator. A coating-type mold-releasing rubber can be obtained by mixing the rubber composition with at least one kind of light naphtha, hexane, toluene and methyl ether ketone in a mixing ratio of 10:90 (the amount of the rubber composition is regarded as 10).

These mold-releasing rubbers exhibit satisfactory mold releasability without bonding with a bladder rubber since the mold-releasing rubber itself is thermocured by vulcanization in the heating step using a bladder.

When the mold-releasing rubber is used as the mold-releasing agent, it is preferred to spray or coat one surface side to be contacted with the bladder of the unvulcanized polymer sheet so that the thickness of the mold-releasing rubber becomes 0.001 to 0.1 mm. When the thickness of the mold-releasing rubber is less than 0.001 mm, the mold-releasing rubber may be broken by the pressure of the bladder in the vulcanization step. It is not preferred that the thickness of the mold-releasing rubber is more than 0.1 mm since weight saving of the tire cannot be achieved. Furthermore, the number of production steps increases and it is not preferred in view of productive efficiency. The thickness of the mold-releasing rubber is more preferably from 0.005 to 0.05 mm.

The Shore A hardness of the polymer sheet for an inner liner after vulcanization is preferably within a range from 25 to 65. When the Shore A hardness is 25 or more, the polymer sheet for an inner liner has satisfactory mechanical strength. When the Shore A hardness is 65 or less, it is possible to prevent deterioration of durability due to too high a hardness of the polymer sheet for an inner liner. The Shore A hardness is more preferably 40 or more, still more preferably 42 or more, and even more preferably 45 or more, and more preferably 62 or less, and still more preferably 58 or less. The Shore A hardness is the value measured in accordance with JIS K 6253.

The specific gravity of the polymer sheet for an inner liner is preferably 1.70 or less. When the specific gravity is 1.70 or less, a satisfactory effect of improving fuel efficiency due to weight saving of the tire is exerted. The specific gravity is more preferably 1.40 or less, and still more preferably 1.20 or less.

### <Structure of Pneumatic Tire>

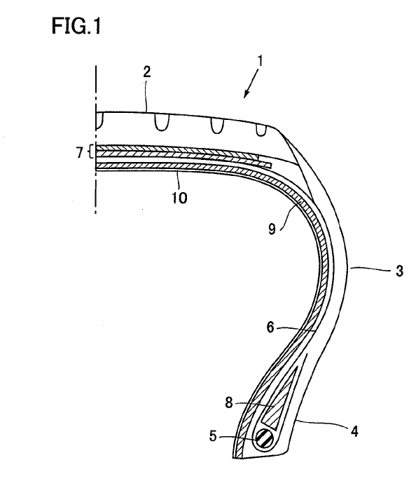

The pneumatic tire produced by the method for producing a pneumatic tire according to the present invention will be described with reference to FIG. 1.

The pneumatic tire produced by the present invention can be used as tires for passenger cars, trucks and buses, and heavy duty equipment. A pneumatic tire 1 includes a tread part 2, a side wall part 3 and a bead part 4. Furthermore, a bead core 5 is embedded in bead part 4. Also provided are a carcass 6 whose ends are respectively folded around bead core 5 and latched, that is provided from one bead part 4 to the other bead part, and a belt layer 7 composed of two plies outside a crown part of carcass 6. An inner liner 9 extending from one bead part 4 to the other bead part 4 is disposed on the tire radial inner surface of carcass 6. Furthermore, a mold-releasing agent layer 10 is disposed on the tire radial inner surface of inner liner 9. Belt layer 7 is disposed so that cords are mutually intersected between two plies composed of a steel cord or an aramid fiber cord at an angle of usually 5 to 30° in a tire circumferential direction. Regarding the carcass, organic fiber cords made of polyester, nylon or aramid are arranged at an angle of about 90° in tire circumferential direction, and a bead apex 8 extending from the top of bead core 5 in a side wall direction is disposed in the region surrounded by the carcass and the folded part thereof.

### <Method for Producing Pneumatic Tire>

In one embodiment of the present invention, the method for producing a pneumatic tire includes the following steps. A green tire including an inner liner made of a polymer mixture containing 99 to 60% by mass of a styrene-isobutylene-styrene triblock copolymer and 1 to 40% by mass of a polyamide-based polymer containing polyamide in the molecular chain and having a Shore D hardness of 70 or less is prepared. The green tire radial inner surface of the inner liner is coated with a mold-releasing agent.

### <Step of Preparing Green Tire>

The green tire used in one embodiment of the present invention includes an inner liner made of a polymer mixture containing 99 to 60% by mass of a styrene-isobutylene-styrene triblock copolymer and 1 to 40% by mass of a polyamide-based polymer containing polyamide in the molecular chain and having a Shore D hardness of 70 or less.

As the polymer mixture, the same polymer mixture as that used in the step of preparing an unvulcanized polymer sheet can be used.

The green tire can be produced by a conventionally known method. Examples of the method include a method in which materials of a polymer mixture are weighed according to a predetermined formulation and kneaded at 100 to 250° C. for 5 to 60 minutes using a rubber kneader such as an open roll or a Banbury mixer to prepare an unvulcanized polymer mixture, and then the unvulcanized polymer mixture is extruded conforming to the shape of an inner liner and pressed on a tire molding machine, together with other members.

<Step of Coating Radial Inner Surface of Green Tire of Inner Liner with Mold-Releasing Agent>

Next, in the green tire thus prepared, the green tire radial inner surface of the inner liner is coated with a mold-releasing agent. In the green tire before the vulcanization step, when the green tire radial inner surface of the inner liner is coated with the mold-releasing agent, it is possible to prevent adhesion between the inner liner and the bladder in the vulcanization step using the bladder, to improve mold releasability, to prevent an air-in phenomenon and to improve appearance of the tire.

As the mold mold-releasing agent, the same mold-releasing agent as that used in the step of coating one surface of the unvulcanized polymer sheet with the mold-releasing agent can be used.

When the water-soluble paint is used as the mold-releasing agent, it is preferred to coat the green tire radical inner surface of the inner liner with a water-soluble paint 2 to 5 times. When the number of coating times of the water-soluble paint is less than 2, mold releasability between the inner liner and the bladder after vulcanization deteriorates and an air-in phenomenon may occur. When the number of coating times of the water-soluble paint is more than 5, the number of production steps increases and it is not preferred in view of productive efficiency. The number of coating times of the water-soluble paint is more preferably from 3 to 4.

As the coating method of a water-soluble paint, dipping can be used.

When a mold-releasing rubber is used as the mold-releasing agent, it is preferred to spray or coat the radial inner surface of a green tire of an inner liner so that the thickness of the mold-releasing rubber is within a range from 0.001 to 0.1 mm When the thickness of the mold-releasing rubber is less than 0.001 mm, the mold-releasing rubber may be broken by the pressure of the bladder in the vulcanization step. It is not preferred that the thickness of the mold-releasing rubber is more than 0.1 mm since weight saving of the tire cannot be achieved. Furthermore, the number of production steps increases and it is not preferred in view of productive efficiency. The thickness of the mold-releasing rubber is more preferably from 0.005 to 0.05 mm.

As the coating method of a spray-type mold-releasing rubber, a spray gun can be used. As the coating method of a coating-type mold-releasing rubber, roller coating, brush coating, a roll coater and a flow coater can be used.

### EXAMPLES

The present invention will be described specifically by way of examples, but the present invention is not limited only thereto.

### Examples 1 to 10, Comparative Examples 1 to 11

According to each formulation shown in Table 1, a polymer mixture component and a filler were charged in a twin screw extruder (screw diameter: φ50 mm, L/D: 30, cylinder temperature: 220° C.) and pelletized, and then an unvulcanized polymer sheet was produced by a T die extruder (screw diameter: φ80 mm, L/D: 50, die lip width: 500 mm, cylinder temperature: 220° C., film gauge: 0.3 mm).

One surface of the unvulcanized polymer sheet was coated and/or sprayed with a mold-releasing agent under the conditions shown in Table 1 to obtain a polymer sheet for an inner liner. The used mold-releasing agent was obtained by the following method.

The water-soluble paint was prepared by sufficiently mixing a mixed liquid containing 45% by mass of talc (D1000, manufactured by Nippon Talc Co., Ltd.), 15% by mass of a silicone emulsion (Wacker E2891, manufactured by Wacker Asahikasei Silicone Co., Ltd.), 5% by mass of a surfactant (PEGNOL S-4D, manufactured by TOHO Chemical Industry Co., Ltd.) and 35% by mass of water under stirring, passing the liquid through a paint roll and filtering the liquid through a 80 mesh filter.

The spray-type mold-releasing rubber was prepared by adding 50 parts by mass of carbon black (FEF, manufactured by TOKAI CARBON CO., LTD.), 2 parts by mass of stearic acid (stearic acid, manufactured by NOF CORPORATION), 4 parts by mass of zinc white (zinc white No. 1, manufactured by MITSUI MINING & SMELTING CO., LTD.), 0.5 part by mass of a vulcanization accelerator CZ (NOCCELER CZ, manufactured by OUCHI SHINKO CHEMICAL INDUSTRIAL CO., LTD.) and 1 part by mass of sulfur (powdered sulfur, manufactured by Tsurumi Chemical Co., Ltd.) were added to 100 parts by mass of a natural rubber, kneading the mixture using a rubber kneader such as a Banbury mixer, a kneader or a roll to give a rubber composition, and sufficiently mixing the rubber composition with naphtha in a ratio of 1/30 under stirring.

The coating-type mold-releasing rubber was prepared by preparing a rubber composition similar to the spray-type mold-releasing rubber and sufficiently mixing the rubber composition with naphtha in a ratio of 1/5 under stirring.

Regarding the pneumatic tire, the polymer sheet for an inner liner was applied to an inner liner portion of a tire, followed by press molding at 170° C. for 20 minutes to obtain a tire of 195/65R15 size.

The polymer sheet for an inner liner was subjected to the following tests and evaluations.

### <Peeling Test>

A 2 mm thick bladder rubber sheet, a 1 mm thick polymer sheet for an inner liner and a reinforced canvas cloth were laid one upon another in the above order, followed by heating under pressure at 170° C. for 12 minutes to obtain a test piece for peeling. They were laid one upon another so that the surface coated with a mold-releasing agent of the polymer sheet for an inner liner is contacted with the bladder rubber sheet. Using the resultant test piece, a peeling test was performed in accordance with JIS K 6256 “Vulcanized Rubber and Thermoplastic Rubber—How to Determine Adhesion” and an adhesive force of the inner liner and the bladder (IL/bladder adhesive force) was measured. The size of the test piece was 25 mm in width and the peeling test was performed at room temperature of 23° C.

The smaller the adhesive force of the inner liner (IL) and the bladder, the more excellent the mold releasability, and the adhesive force is preferably 10 N or less, and more preferably 5 N or less.

### <Air Permeability Test>

In accordance with ASTM D 1434 75M, the air permeation amount of a polymer sheet for an inner liner vulcanized at 170° C. for 12 minutes was measured. The smaller the air permeation amount, the more excellent the air barrier properties. Therefore, the air permeation amount is preferably 10×10¹¹ cm³·cm/cm²·s·cm·Hg or less, and more preferably 5×10¹¹ cm³·cm/cm²·s·cm·Hg or less.

### <Process Ability>

In the step of extruding a polymer mixture into an unvulcanized polymer sheet and the step of spraying or coating a mold-releasing agent on an unvulcanized polymer sheet, those with excellent productivity were rated “A”, those with satisfactory productivity were rated “B”, and those with poor productivity were rated “D”.

The pneumatic tire was subjected to the following tests and evaluations.

### <Presence or Absence of Air-In>

The inside of the vulcanized tire was examined. As a result, those in which the number of air-in portions with a diameter of 5 mm or less in appearance was 0 per one tire were rated “A”, those in which the number of air-in portions was from 1 to 3 were rated “B”, and those in which the number of air-in portions was 4 or more were rated “D”. Those in which the diameter of an air-in portion was more than 5 mm were rated “D” even when the number of air-in portions was 1.

### <Rolling Resistance Test>

Using a rolling resistance tester manufactured by KOBE STEEL., LTD., the obtained 195/65R15 steel radial PC tire was mounted on a JIS standard rim (15×6JJ), and rolling resistance was measured while driving the tire at room temperature (38° C.) under the conditions of a load of 3.4 kN, an air pressure of 230 kPa, and a speed of 80 km/hour. Using the following calculation equation, the rolling resistance change rate (%) of each formulation was expressed by an index (the value of Comparative Example 1 was regarded as ±0). The smaller the rolling resistance change rate, the smaller the rolling resistance, and the more excellent the performance. Specifically, the rolling resistance change rate is preferably a minus value.

(Rolling resistance change rate)=(Rolling resistance of each formulation−Rolling resistance of Comparative Example 1)/(Rolling resistance of Comparative Example 1)×100

### <Static Air Pressure Drop Test>

The 195/65R15 steel radial PC tire is mounted on a JIS standard rim (15×6JJ) and an initial air pressure of 300 Kpa is applied. After standing at room temperature for 90 days, a decrease rate of an air pressure is calculated.

### <Evaluation Results>

The test results and overall judgment are shown in Table 1 and Table 2.

Criteria of the overall judgment are as shown in Table 3.

TABLE 1

Examples

| | | | 1 | 2 | 3 | 4 | 5 | 6 | 7 | 8 | 9 | 10 |
|---|---|---|---|---|---|---|---|---|---|---|---|---|
| Compounding | Polymer | SIBS^{(Note 1)} | 90 | 90 | 90 | 90 | 90 | 90 | 90 | 90 | 70 | 70 |
| agent | mixture | Polyamide-based | 10 | 10 | 10 | 10 | 10 | 10 | 10 | 10 | 10 | 10 |
| (parts by mass) | component | polymer^{(Note 2)} | | | | | | | | | | |
| | | Ethylene-vinyl alcohol | — | — | — | — | — | — | — | — | 20 | 20 |
| | | copolymer^{(Note 3)} | | | | | | | | | | |
| | | Chlorobutyl^{(Note 4)} | — | — | — | — | — | — | — | — | — | — |
| | | NR^{(Note 5)} | — | — | — | — | — | — | — | — | — | — |
| | Filler^{(Note 6)} | | — | — | — | — | — | — | — | — | — | — |
| Mold-releasing | Water-soluble paint (times) | | 2 | 5 | — | — | — | — | 5 | 5 | 5 | 5 |
| agent | Spray-type mold-releasing rubber (mm) | | — | — | 0.001 | 0.1 | — | — | 0.1 | — | 0.1 | — |
| | Coating-type mold-releasing rubber (mm) | | — | — | — | — | 0.001 | 0.1 | — | 0.1 | — | 0.1 |
| Evaluation | Polymer | IL/bladder adhesive force | 12 | 4.4 | 10 | 4 | 10 | 4 | 2 | 2 | 6 | 6 |
| | sheet for | (N/25 mm) | | | | | | | | | | |
| | inner liner | Air permeation amount | 4.3 | 3.8 | 4.4 | 3.7 | 4.4 | 3.7 | 3.2 | 3.2 | 4.4 | 4.4 |
| | | (10¹¹ cm³ · cm/cm² · | | | | | | | | | | |
| | | s · cm · Hg) | | | | | | | | | | |
| | | Processability | A | A | A | A | A | A | A | A | A | A |
| | Tire | Presence or absence of air-in | B | A | B | A | B | A | A | A | B | B |
| | | Rolling resistance change rate | −4.9 | −4.4 | −5.3 | −4.6 | −5.3 | −4.6 | −3.8 | −3.8 | −3.6 | −3.6 |
| | | (%) | | | | | | | | | | |
| | | Static air pressure drop rate | 2.5 | 2.2 | 2.7 | 2.0 | 2.7 | 2.0 | 1.8 | 1.8 | 2.7 | 2.7 |
| | | (%/month) | | | | | | | | | | |

| | | | | | | | | | | |
|---|---|---|---|---|---|---|---|---|---|---|
| Overall judgment | B | A | B | A | B | A | A | A | B | B |

TABLE 2

| | | | Comparative Examples | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Compounding | Polymer | SIBS^{(Note 1)} | — | 50 | 100 | — | — | 90 | 90 | 90 | 90 | 90 | 90 |
| agent | mixture | Polyamide-based | — | 50 | — | 100 | — | 10 | 10 | 10 | 10 | 10 | 10 |
| (parts by mass) | component | polymer^{(Note 2)} | | | | | | | | | | | |
| | | Ethylene-vinyl alcohol | — | — | — | — | 100 | — | — | — | — | — | — |
| | | copolymer^{(Note 3)} | | | | | | | | | | | |
| | | Chlorobutyl^{(Note 4)} | 80 | — | — | — | — | — | — | — | — | — | — |
| | | NR^{(Note 5)} | 20 | — | — | — | — | — | — | — | — | — | — |
| | Filler^{(Note 6)} | | — | — | — | — | — | — | — | — | — | — | — |
| Mold-releasing | Water-soluble paint (times) | | — | 5 | 5 | 5 | 5 | 1 | 6 | — | — | — | — |
| agent | Spray-type mold-releasing rubber (mm) | | — | 0.1 | 0.1 | 0.1 | 0.1 | — | — | 0.0005 | 0.15 | — | — |
| | Coating-type mold-releasing rubber (mm) | | — | — | — | — | — | — | — | — | — | 0.0005 | 0.15 |
| Evaluation | Polymer | IL/bladder adhesive force | 12 | 5 | 5 | 5 | 5 | 16 | 6 | 16 | 4 | 16 | 4 |
| | sheet for | (N/25 mm) | | | | | | | | | | | |
| | inner liner | Air permeation amount | 12.2 | 8.1 | 3.5 | 18.5 | 10.0 | 4.5 | 3.6 | 4.5 | 6.3 | 4.5 | 3.6 |
| | | (10¹¹ cm³ · cm/cm² · | | | | | | | | | | | |
| | | s · cm · Hg) | | | | | | | | | | | |
| | | Processability | B | D | D | D | D | B | D | B | D | B | D |
| | Tire | Presence or absence of air-in | B | D | D | D | D | D | A | D | A | D | A |
| | | Rolling resistance change rate | Standard | −5.2 | −5.0 | −3.5 | −3.6 | −4.9 | −4.0 | −5.3 | −4.0 | −5.3 | −4.0 |
| | | (%) | (0) | | | | | | | | | | |
| | | Static air pressure drop rate | 4.0 | 3.2 | 1.8 | 10.2 | 7.2 | 3.0 | 2.1 | 3.1 | 2.1 | 3.1 | 2.1 |
| | | (%/month) | | | | | | | | | | | |

| | | | | | | | | | | | |
|---|---|---|---|---|---|---|---|---|---|---|---|
| Overall judgment | C | D | D | D | D | D | D | D | D | D | D |

^{(Note 1)}SIBS: “SIBSTAR 102T” (Shore A hardness of 25, styrene unit content of 25% by mass) manufactured by Kaneka Corporation
^{(Note 2)}Polyamide-based polymer: “UBESTA XPA 9040 (Shore D hardness of 40)” manufactured by Ube Industries, Ltd.
^{(Note 3)}Ethylene-vinyl alcohol copolymer: “EVAL E105” manufactured by KURARAY CO., LTD.
^{(Note 4)}Chlorobutyl: “Exxon chlorobutyl 1068” manufactured by Exxon Mobil Corporation
^{(Note 5)}NR (natural rubber): TSR20
^{(Note 6)}Filler: “SEAST V” (N660, N₂SA of 27 m²/g) manufactured by Tokai Carbon Co., Ltd.

TABLE 3

| | | | | (c) Rolling | (d) Static air |
|---|---|---|---|---|---|
| Overall | | (a) IL/bladder adhesive | (b) Air permeation amount | resistance | pressure drop rate |
| judgment | Criteria | force (N/25 mm) | (10¹¹ cm³ · cm/cm² · s · cm · Hg) | change rate (%) | (%/month) |
| A | (a) to (d) satisfy all | 5 or less | 4.4 or less | −3.8 or less | 2.2 or less |
| | criteria described in right | | | | |
| | columns | | | | |
| B | (a) to (d) satisfy one or | 6 to 10 | 4.5 to 10 | −3.7 to −0.1 | 2.3 to 3.0 |
| | more criteria described in | | | | |
| | right columns | | | | |
| C | (a) to (d) satisfy one or | 11 to 15 | 10.1 to 13 | 0 or more | 3.1 to 10.0 |
| | more criteria described in | | | | |
| | right columns | | | | |
| D | (a) to (d) satisfy one or | 16 or more | 13.1 or more | 0 or more | 10.1 or more |
| | more criteria described in | | | | |
| | right columns | | | | |

In Examples 1 to 6, an unvulcanized polymer sheet made of a polymer mixture containing 90% by mass of a styrene-isobutylene-styrene triblock copolymer and 10% by mass of a polyamide-based polymer containing polyamide in the molecular chain and having a Shore D hardness of 70 or less was coated with a water-soluble paint as a mold-releasing agent 2 or 5 times, or sprayed with a spray-type mold-releasing rubber in a thickness of 0.001 mm or 0.1 mm, or coated with a coating-type mold-releasing rubber in a thickness of 0.001 mm or 0.1 mm. The resultant polymer sheet for an inner liner showed satisfactory mold releasability from the bladder, and an air-in phenomenon was prevented. Furthermore, a pneumatic tire using the polymer sheet for an inner liner decreased the rolling resistance and static air pressure drop rate.

In Examples 7 and 8, an unvulcanized polymer sheet made of a polymer mixture containing 90% by mass of a styrene-isobutylene-styrene triblock copolymer and 10% by mass of a polyamide-based polymer containing polyamide in the molecular chain and having a Shore D hardness of 70 or less was coated with a water-soluble paint as a mold-releasing agent 5 times and also sprayed with a spray-type mold-releasing rubber in a thickness of 0.1 mm, or coated with a coating-type mold-releasing rubber in a thickness of 0.1 mm. The resultant polymer sheet for an inner liner showed excellent mold releasability from the bladder, and an air-in phenomenon was prevented. Furthermore, a pneumatic tire using the polymer sheet for an inner liner decreased the rolling resistance and static air pressure drop rate.

In Examples 9 and 10, an unvulcanized polymer sheet made of a polymer mixture containing 70% by mass of a styrene-isobutylene-styrene triblock copolymer, 10% by mass of a polyamide-based polymer containing polyamide in the molecular chain and having a Shore D hardness of 70 or less and 20% by mass of an ethylene-vinyl alcohol copolymer was coated with a water-soluble paint as a mold-releasing agent 5 times and also sprayed with a spray-type mold-releasing rubber in a thickness of 0.1 mm, or coated with a coating-type mold-releasing rubber in a thickness of 0.1 mm. The resultant polymer sheet for an inner liner showed satisfactory mold releasability from the bladder, and an air-in phenomenon was prevented. Furthermore, a pneumatic tire using the polymer sheet for an inner liner decreased the rolling resistance and static air pressure drop rate.

In Comparative Example 1, a polymer sheet for an inner liner was produced using a conventional rubber composition for an inner liner composed of 80% by mass of chlorobutyl and 20% by mass of a natural rubber. The polymer sheet was inferior in the air permeation resistance and resistance to static air pressure drop as compared with Examples 1 to 10.

In Comparative Example 2, an unvulcanized polymer sheet made of a polymer mixture containing 50% by mass of a styrene-isobutylene-styrene triblock copolymer and 50% by mass of a polyamide-based polymer containing polyamide in the molecular chain and having a Shore D hardness of 70 or less was coated with a water-soluble paint as a mold-releasing agent 5 times and also sprayed with a spray-type mold-releasing rubber in a thickness of 0.1 mm, or coated with a coating-type mold-releasing rubber in a thickness of 0.1 mm. The resultant polymer sheet for an inner liner contained a small amount of the styrene-isobutylene-styrene triblock copolymer and was inferior in the air permeation resistance and resistance to static air pressure drop.

In Comparative Example 3, an unvulcanized polymer sheet made of a polymer mixture containing 100% by mass of a styrene-isobutylene-styrene triblock copolymer was coated with a water-soluble paint as a mold-releasing agent 5 times and also sprayed with a spray-type mold-releasing rubber in a thickness of 0.1 mm. The resultant polymer sheet for an inner liner was inferior in processability and also an air-in phenomenon occurred.

In Comparative Example 4, an unvulcanized polymer sheet made of a polymer mixture containing 100% by mass of a polyamide-based polymer containing polyamide in the molecular chain and having a Shore D hardness of 70 or less was coated with a water-soluble paint as a mold-releasing agent 5 times and also sprayed with a spray-type mold-releasing rubber in a thickness of 0.1 mm. The resultant polymer sheet for an inner liner was inferior in air permeation resistance and resistance to static air pressure drop. Furthermore, the polymer sheet for an inner liner was inferior in processability and also an air-in phenomenon occurred.

In Comparative Example 5, an unvulcanized polymer sheet made of a polymer mixture containing 100% by mass of an ethylene-vinyl alcohol copolymer was coated with a water-soluble paint as a mold-releasing agent 5 times and also sprayed with a spray-type mold-releasing rubber in a thickness of 0.1 mm. The resultant polymer sheet for an inner liner was inferior in air permeation resistance and resistance to static air pressure drop. Furthermore, the polymer sheet for an inner liner was inferior in processability and also an air-in phenomenon occurred.

In Comparative Examples 6 to 11, an unvulcanized polymer sheet made of a polymer mixture containing 90% by mass of a styrene-isobutylene-styrene triblock copolymer and 10% by mass of a polyamide-based polymer containing polyamide in the molecular chain and having a Shore D hardness of 70 or less was coated with a water-soluble paint as a mold-releasing agent 1 time or 6 times and also sprayed with a spray-type mold-releasing rubber in a thickness of 0.0005 mm or 0.15 mm, or coated with a coating-type mold-releasing rubber in a thickness of 0.0005 mm or 0.15 mm The polymer sheets for an inner liner of Comparative Examples 6, 8 and 10 were inferior in the mold releasability from the bladder. Comparative Examples 7, 9 and 11 were inferior in productive efficiency because of a lot of coating and spray steps of a mold-releasing agent.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method for producing a polymer sheet for an inner liner, comprising the steps of:
preparing an unvulcanized polymer sheet made of a polymer mixture containing 99 to 60% by mass of a styrene-isobutylene-styrene triblock copolymer, and 1 to 40% by mass of a polyamide-based polymer containing polyamide in the molecular chain and having a Shore D hardness of 70 or less, and
at least one of the steps of coating one surface of said unvulcanized polymer sheet with a water-soluble paint 2 to 5 times, and coating with a mold-releasing rubber in a thickness of 0.001 mm to 0.1 mm.

2. The method for producing a polymer sheet for an inner liner according to claim 1, wherein said polymer mixture contains 15 to 30% by mass of an ethylene-vinyl alcohol copolymer.

3. The method for producing a polymer sheet for an inner liner according to claim 1, wherein said styrene-isobutylene-styrene triblock copolymer contains 10 to 30% by mass of a styrene unit.

4. The method for producing a polymer sheet for an inner liner according to claim 1, wherein said polyamide-based polymer is a block copolymer of a polyamide component and a polyether component.

5. A method for producing a pneumatic tire, comprising the steps of:
preparing a green tire with an inner liner made of a polymer mixture containing 99 to 60% by mass of a styrene-isobutylene-styrene triblock copolymer, and 1 to 40% by mass of a polyamide-based polymer containing polyamide in the molecular chain and having a Shore D hardness of 70 or less,
and any one of the steps of coating a radial inner surface of said green tire of said green inner liner with a water-soluble paint 2 to 5 times, and coating with a mold-releasing rubber in a thickness of 0.001 mm to 0.1 mm.

6. The method for producing a pneumatic tire according to claim 5, wherein said polymer mixture contains 15 to 30% by mass of an ethylene-vinyl alcohol copolymer.

7. The method for producing a pneumatic tire according to claim 5, wherein said styrene-isobutylene-styrene triblock copolymer contains 10 to 30% by mass of a styrene unit.

8. The method for producing a pneumatic tire according to claim 5, wherein said polyamide-based polymer is a block copolymer of a polyamide component and a polyether component.
